(19) United States
(12) Patent Application Publication
(10) Pub. No.: US 2009/0313358 A1
(43) Pub. Date: Dec. 17, 2009

(54) System and Method for Managing Network-Based Services

(75) Inventors: Charles Shepherd, Dacula, GA (US); Anil Sonowane, Alpharetta, GA (US)

Correspondence Address: KAPLAN WARD & PATEL LLC, CUMBERLAND CENTER II, 3100 CUMBERLAND BLVD , SUITE 1400, ATLANTA, GA, 30339, US

(73) Assignee: Shepherd's Pie Productions, Inc.

(21) Appl. No.: 12/138,256

(22) Filed: Jun. 12, 2008

(51) Int. Cl. G06F 15/177

(52) U.S. Cl. 709/221; 709/220

(57) ABSTRACT

Systems and methods for managing computer network based services that provide a customized service to a user via any of a plurality of access points utilizing a portable user configuration to automatically configure a selected access point, wherein the customized service is provided according to the user configuration. The systems and methods further provide management functions for operation, control, and/or monitoring of the systems to provide an integrated service solution.

### TECHNICAL FIELD

The present invention relates generally to business methods and computer systems, and, more particularly, to systems and methods for managing network-based services.

### BACKGROUND OF THE INVENTION

Many services, including retail services, governmental services, and the like, rely on computers and computer systems, and particularly on networked computer systems, for delivery, monitoring, control, accounting, or other aspect(s) of the services. Especially where the services are provided for a fee, or are otherwise restricted, accounts may be used within the system to control access, track usage, and otherwise manage the service. Unfortunately, however, user accounts in such computer systems for services have not previously been employed for improving a user's experience while using the service.

For example, in a system where the service may be accessed from any of a plurality of access points, the user may typically access the system from a convenient one of such access points upon the provision of identification information associated with the user's account, whereafter the user is provided with a generic experience. For many services, such generic experience is not ideal, and may prevent the user from achieving a desired level of enjoyment, efficiency, of the like in use of the service. Even where a user may subsequently configure the access point to provide a customized experience, the requirement for such repeated customization of an access point may be inconvenient or impractical. For example, where the user has limited time, or where the system requires substantial configuration to provide the desired or required experience, the user may practically be prevented from using the service. In this situation, both the user and the service provider suffer the lost opportunity.

Thus, it is clear that there is an unmet need for a system and method for managing a service that enables provision of a customized service experience that is automatically portable to any of a plurality of access points of the system.

### BRIEF SUMMARY OF THE INVENTION

Briefly described, in a preferred embodiment, the system and method of the present disclosure overcome the above-mentioned disadvantages and meet the recognized need for such a system and method by providing a system operable to deliver a customized service experience utilizing a computer network having a plurality of access points.

More specifically, the system is preferably operable to provide the service in a customized manner based on one or more setting, preference, configuration, instruction, or the like of a user account associated with the user. The setting, preference, configuration, instruction, or the like, collectively referred to as a configuration, preferably operates to control an access point of the system to deliver the service in the customized manner. Thus, when a user accesses the system, and thereby the service, the access point may automatically be controlled by the system according to the user's associated configuration, whereby a customized service experience may be portable to different access points of a network via automatic portability of the user's configuration.

Accordingly, one feature and advantage of the present system and method is the ability to deliver a customized, and therefore preferred, user experience to users within a service network.

Another feature and advantage of the present system and method is the ability to increase the effectiveness and/or efficiency of use of the system by elimination or reduction of repeated configuration of one or more access point of the system.

These and many other features and advantages of the systems and methods of the present disclosure will become more apparent to those ordinarily skilled in the art after reading the following Detailed Description of the Invention and Claims in light of the accompanying drawing Figures.

### BRIEF DESCRIPTION OF THE DRAWINGS

Accordingly, the present disclosure will be understood best through consideration of, and with reference to, the following drawings, viewed in conjunction with the Detailed Description of the Invention referring thereto, in which like reference numbers throughout the various drawings designate like structure, and in which:

FIG. 1 is a diagram of a system for providing computer-based services;

FIG. 2 is a flow chart illustrating a method of providing a providing a customized service to a user;

FIG. 3 is a diagram of an exemplary embodiment of the system of FIG. 1;

FIG. 4 is an illustration of a customized display of the exemplary system of FIG. 3; and

FIG. 5 is an illustration of display of the system of FIG. 3.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the system and method of the present disclosure illustrated in the drawings, specific terminology is employed for the sake of clarity. The claimed invention, however, is not intended to be limited to the specific terminology so selected, and it is to be understood that each specific element includes all technical equivalents that operate in a similar manner to accomplish a similar purpose.

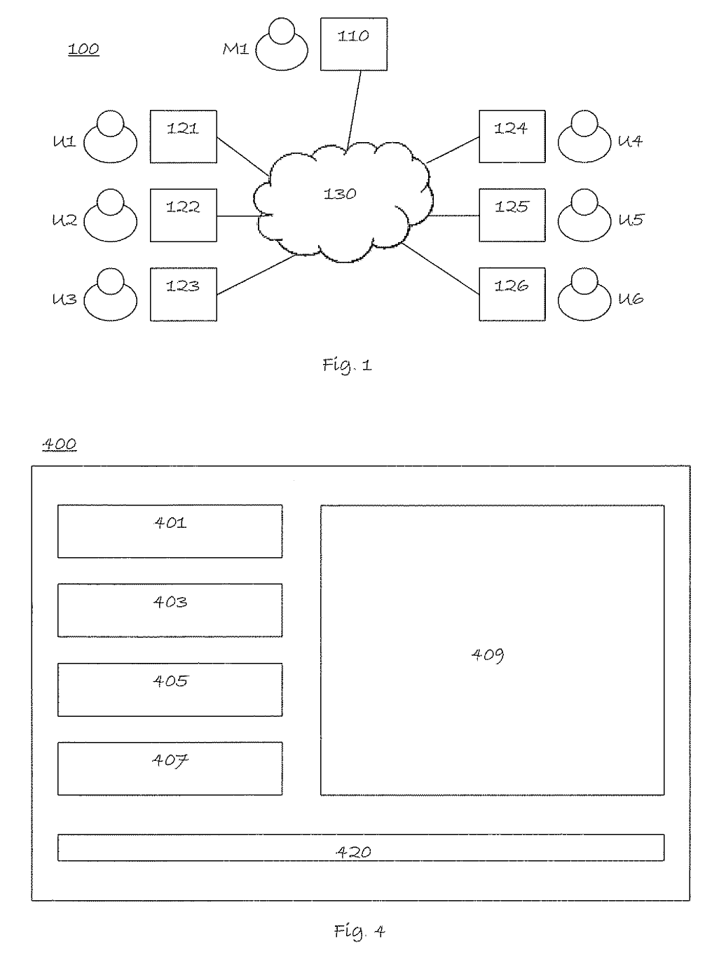

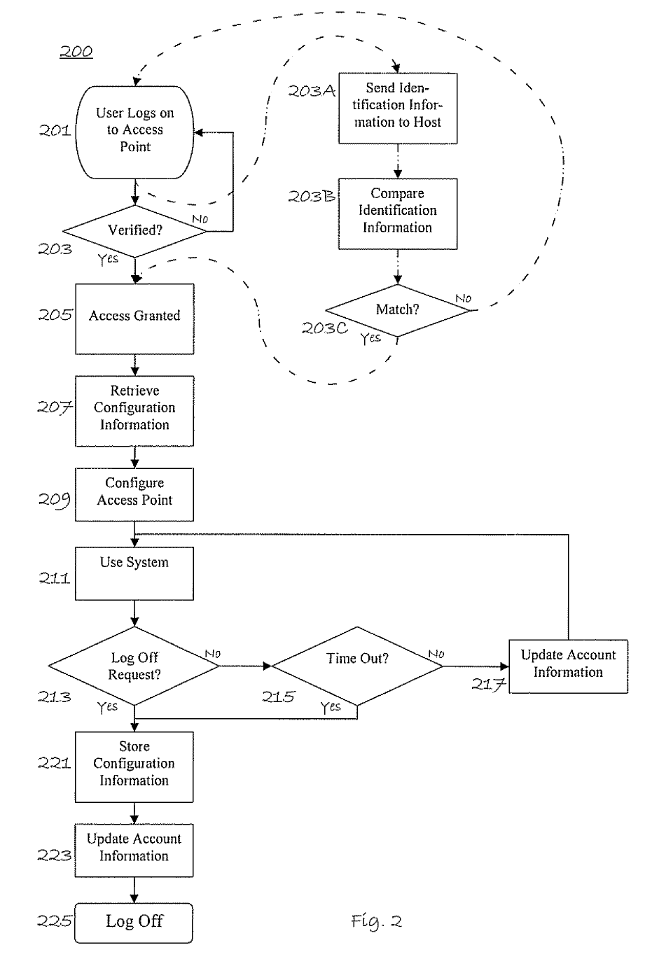

In the embodiment of the present system and method chosen for purposes of illustration in FIGS. 1 and 2, system 100 preferably includes host 110, operable to provide a service to a plurality of users, such as users U1-U6. Accordingly, host 110 is preferably formed as a computer, having a processor, one or more storage device(s), one or more communication device(s), a plurality of input devices, a plurality of output devices, a power supply, and the like, as is known in the art. For complex or robust services, or simply where necessary or desirable for cost, efficiency, performance, reliability, or other interest, host 110 may be formed as a plurality of computers, storage devices, networking components, and/or the like. Provision or delivery of the service by host 110 is preferably managed by manager M1. For this purpose, manager M1 may be an individual operator, a plurality of individual operators, a computer program product operable with host 110, combinations thereof, or the like.

Each of users U1-U6 may access the service by connecting to host 110 via an associated one of access points 121-126 and network 130. Each of access points 121-126 is preferably a service delivery device that is operable to provide an output to a respective user that is the end result of the service. For this purpose, each of access points 121-126 may be configured as a personal computer, such as a desktop or laptop computer, a portable electronic device, such as a cellular communication device, a satellite transceiver, a radio device, or the like, a dedicated terminal, a network component, such as an Ethernet port, a wireless hub or router, or the like, and/or combinations thereof.

For example, where the service provided by system 100 is a conventional business service, such as package shipping service, automated banking service, retail check-out service, or the like, access points 121-126 may be configured as dedicated terminals located at one or more retail location, package drop site, or the like. Using shipping services as an example, access points 121-126 are preferably operable to allow an associated user to purchase package shipping services, including specification of a service selection (expedited vs. regular), recipient information, delivery address or location, insurance selection, handling instructions, payment, or the like. Thus, the terminal may include a processor, a storage device, a computer program product stored on the storage device, a communication device for communication with host 110 via network 130, and input and output devices with which a user may interact. Where the access point is located at an operation site of the business, network 130 may be configured as a local area network, such as a wired or wireless network. Where the access point is located at a remote location, however, such as a drop-box or a customer pick-up location, network 130 may be configured as a wide-area network, such as a proprietary wide-area network or a shared wide-area network like the Internet, a satellite network, or the like.

Alternatively, however, such as where the service provided by system 100 is an Internet access service, such as may be offered in a retail business (such as coffee shops or the like), an airport facility, or other public facility, or as may be offered in a hotel room, conference room, or other semi-private facility, or the like, each of access points 121-126 may be configured as a networking device operable to provide Internet access (or access to another public or proprietary network), such as a router, a hub, or other networking device. Accordingly, a user may use an associated device, such as a laptop computer or other Internet enabled device to access the Internet via one of access points 121-126, i.e. via the networking device.

As a further alternative, such as in a computer lab, a library, a business center, and office, or the like, access points 121-126 may be configured as a plurality of personal computers operable to provide computing services, access to computer program services, access to databases or other information, computer or computer-based training services, Internet access, or the like. For example, in a library setting, access points 121-126 may be used to locate and retrieve information pertaining to inventory of the library or library system. The access points may further be used for public Internet access, for word processing, for printing, or the like. In other settings, the access points may likewise be used to provide access to any of a plurality of computer software program services and information access. For such purposes, each personal computer may include input and output devices, such as a keyboard, mouse, monitor, speakers, microphone, printer, scanner, or the like, a processor, a storage device, and a networking device.

As will be understood by those ordinarily skilled in the art, each access point is preferably operable with host 110 for control, management, and/or monitoring thereof. For example, host 110 preferably includes a computer program product stored on a storage device thereof, wherein such program is operable to control, manage, and monitor system 100 via a respective client program operable with each access point. The computer program product is preferably operable with one or more database(s) stored on one or more storage device(s) of host 110 to create, access, maintain, and/or modify a plurality of user accounts, each user account associated with a respective one of a plurality of users, such as users U1-U6. Each account preferably includes information pertaining to a corresponding user, such as identification information, personal information, billing information, and/or configuration information, or the like. Additionally, the computer program product may be operable with one or more database(s) stored on one or more storage device(s) to create, access, maintain, and/or modify a plurality of employee and/or facility accounts associated with a respective employee (including one or more manager) and with a lo respective location (whether virtual or geographic).

The computer program product is preferably operable to monitor host 110, access points 121-126, and/or network 130, and to record information corresponding to selected details of the activity of system 100. The computer program product may use such recorded information to automatically update user accounts according to desired parameters, such as, according to usage of system 100, to automatically generate activity reports, including financial reports and/or system performance reports, to detect and alert manager M1 of the occurrence of predefined or preselected activity, or the like. The computer program product is preferably further operable to receive and execute commands provided by manager M1, including commands to control, deactivate, or monitor one or more of access points 121-126, network 130, and/or one or more selected user account, or the like.

Furthermore, the computer program product is preferably operable to automatically control each of access points 121-126, such as by altering a configuration thereof according to the configuration information of an account corresponding to a user currently associated with one of the access points. For example, and with specific reference to FIG. 2, method 200 may begin when user U1 may log on to access point 121 at step 201. User U1 may log on to access point 121, or any other selected access point, by providing unique identification information, such as a user name and password combination, biometric identification information, information contained on a portable storage device, such as a magnetic strip or memory chip of a card or other device, or the like. The identification information is then verified by the computer program product at step 203. If the verification is successful, access may be granted at step 205 and access point 121 may be temporarily associated with user U1, and if not successfully verified, access is denied and the user may retry to log on to access point 121. For example, access point 121 may preferably transmit such identification or other credential to host 110 via network 130 at alternate step 203A, whereafter host 110 may authenticate such information or credential at alternate step 203B, such as via comparison with information associated with user accounts. If and when host 110 determines at alternate step 203C that the information provided in step 201 is matched with information associated with a user account, user U1 is identified and granted access to system 100 at step 205. If, however, host 110 determines at step 203C that the information provided in step 201 does not match information associated with any user account, then access to system 100 may be denied. The computer program product may optionally permit subsequent access attempts, and preferably maintains a record of all access attempts, failed and successful, for management and/or accounting purposes.

When user U1 is permitted to log on to access point 121, the computer program product preferably automatically retrieves configuration information of an account associated with user U1 at step 207, and further preferably automatically configures access point 121 according to the configuration information at step 209. User U1 is then preferably permitted to use system 100 and one or more service provided thereby at step 211, according to permission and decisions, such as permissions associated with the user account of user U1, or the like. The computer program product preferably monitors, such as continuously or periodically, whether user U1 requests to log off at step 213. If user U1 requests to log off system 100, the computer program product preferably stores the current configuration information and associates same with the user's account at step 221, updates the user's other account information, such as account usage information, account balances, or the like at step 223, and then logs the user off at step 225. If the user does not request to log off, the computer program product may determine whether the access point 121 has timed out, such as due to inactivity, at step 215. If access point 121 has timed out, then user U1 is preferably automatically logged off by the performance of steps 221, 223, and 225. If access point 121 has not timed out, or alternatively if activity is detected, the computer program product preferably updates the user's account at step 217, such as by decrementing a balance or remaining units of service, incrementing a balance due, or the like, based on monitored and recorded activity of system 100 during use thereof during step 211. After such update at step 217, the user may be permitted to continue using system 100 at step 211.

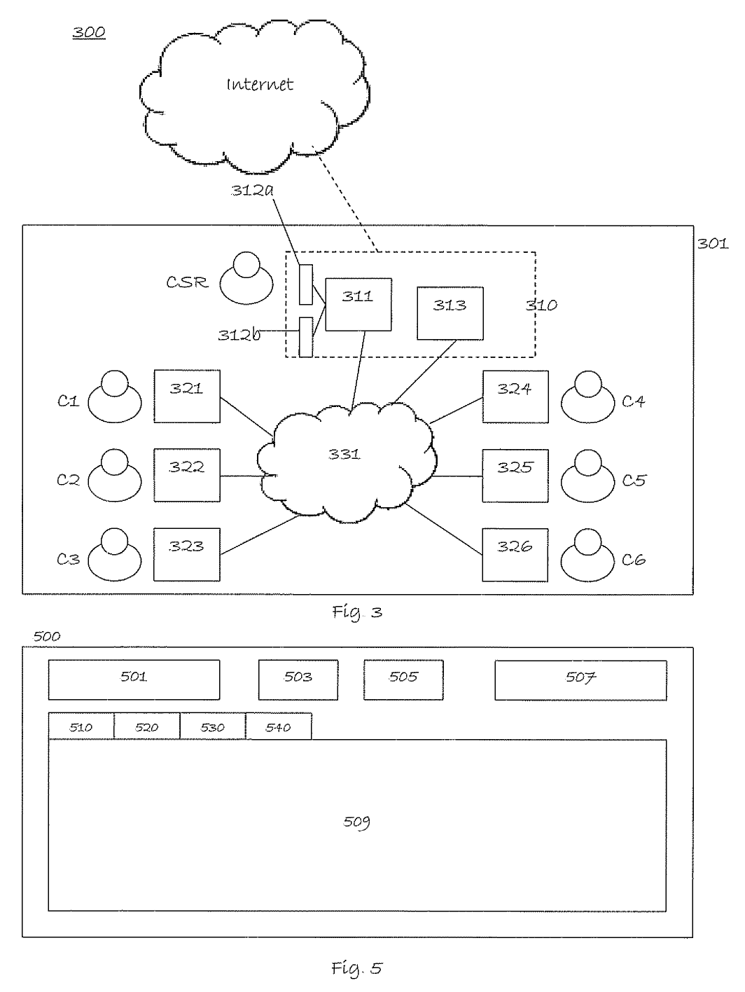

According to a specific exemplary implementation, and with reference to FIG. 3, system 100 may be configured as system 300 adapted to provide Internet access service to customers C1-C6 via terminals 321-326, respectively, at retail location 301. Each of terminals 321 is preferably formed as a personal computer having a processor, a hard drive, RAM, a disc drive, a LAN card, a video card, and audio card, or the like. Each terminal preferably further includes a touch screen display and speakers/headphones for input and/or output. Each terminal preferably includes an operating system, such as a WINDOWS operating system, and is preferably operable to execute one or more selected computer software program operable therewith, such as an Internet browser, email program, word processor, a tutorial program, video game, music player, ancillary software, and/or other desired software.

Each of terminals 321-326 preferably further includes a client program, operable to control the terminal according to one or more instruction provided by customer service representative CSR and/or by host 310, and formed as customer service terminal 311 and/or server 313. The client program is preferably formed as a computer program product stored on the hard drive of each terminal to operate natively at the terminal. Each terminal is preferably configured to boot into the client program, whereby use of a terminal outside of the client program is not permitted. Furthermore, the client program, in conjunction with a server program operable with server 313 and a management program operable with terminal 311, is preferably operable to carry out method 200, or a specific embodiment thereof adapted for use in system 300.

Particularly, the client program of terminal 321 is preferably operable to provide user C1 with customized display 400, illustrated in FIG. 4. Display 400 preferably includes a plurality of input/output areas 401-409 which are configured and arranged according to configuration information of a user account associated with customer C1. For example, display 400 may comprise a home menu, such as a menu provided to customer C1 upon initial log on, wherein areas 401-409 may be used to select a respective service associated with one or more program stored on the hard drive of terminal 321, such as an Internet browser, a word processor, a communication program, such as an email, text messenger, or voice over IP program, a media player, a tutorial, a video game, or the like. Area 420 may preferably be used to access a service associated with a program stored on host 310, such as an account management and/or monitoring feature, a communication program, such as a messaging program disseminating advertisements, or the like.

The configuration information associated with the user account of customer C1 may include information pertaining to how areas 401-409 are to be configured and arranged. Thus, display 400, configured as a menu, preferably automatically provides customer C1 with convenient access to selected programs previously defined by customer C1, and in a manner selected by customer C1. That is to say, the relative location, size, color, respective associated service, or the like associated with each of areas 401-409 may be controlled by the computer program product based on the configuration information. Additionally, the content or settings of some or all of the respective associated services may likewise be controlled to conform to preferences or requirements previously defined by customer C1. Thus, customer C1 preferably receives display 400 regardless of which of access points 321-326 customer C1 selects for use. Furthermore, one or more program or the like referred to in the configuration information need not previously be stored on the hard drive or other storage device of terminal 321 in order for customer C1 to have access thereto. Specifically, at step 209 of method 200, or at an equivalent step of another method, one or more program, file, or the like referred to in the configuration information of a user who is logged on to terminal 321 may automatically be installed or stored thereon, where the user, such as customer C1, may have access to such program, file, or the like at any selected one of terminals 321-326, regardless of whether the user has previously installed or stored the program, file, or the like, on such selected one of access points 321-326.

Similarly, add-on or supplemental program or file information may be included in the configuration information of a user account, whereby programs, including the operating system of an access point, files, or the like, may be configured according to a user's preference. For example, display settings, including resolution setting, desktop background, display theme, desktop icon arrangement, or the like may be configured automatically based on the configuration information of the verified account. Additionally, or alternatively, program settings may be configured according to the configuration information, such as favorite links may be added to an Internet browser, recently used programs and/or files may be added to corresponding listings within the operating system software or other programs, media playlists and/or ratings may be loaded, address books or other contact information may be loaded, or the like.

Now referring more particularly to host 310, customer service terminal 311 is preferably configured as a personal computer having a processor, a hard drive, RAM, a disc drive, a port, a LAN card, a video card, and audio card, or the like. Customer service terminal 311 preferably further includes two touch screen displays 312a and 312b, and appropriate input and/or output devices. Furthermore, customer service terminal 311 preferably includes an operating system, such as a WINDOWS operating system, and is preferably operable to execute a computer program product adapted to manage, control, and/or monitor network 330 and terminals 321-326. More specifically, the computer program product is preferably adapted to provide display 500 to customer service representative CSR via display device 312a. Display 500 preferably includes areas 501 and 507 where information pertaining to system 100 may be displayed, such as a business address, business name, or the like, and where status information, such as information corresponding to a current user of terminal 311, may be displayed.

Areas 503 and 505 are further preferably included and configured as buttons or other operable portion of display 500 to lock and/or log off terminal 311. For example, activation of area 503 may lock terminal 311, such as may be necessary if customer service representative CSR takes a break, or is called away to perform a task, such as assisting a customer. Activation of area 505 preferably logs customer service representative CSR off terminal 311, such as at the end of a shift, or the like.

Additionally, areas 510, 520, 530, and 540 may be included to access various management, control, and/or monitoring functions of the computer program product and/or host 310, and are preferably formed as operable portions of display 500. Activation of any of areas 510, 520, 530, or 540 preferably causes selected information and/or active areas to be displayed in area 509. For example, area 510 may be associated with administrative functions of the computer program product, and selection thereof preferably allows administrative functions to be performed, such as creation, modification, and/or review of employee accounts, performance or end-of-shift or close-of-business routines, such as cash drawer or inventory counting, employee clock-in and clock-out, or the like.

Area 520 may be associated with customer functions of system 300, and selection thereof preferably allows creation, modification, and/or review of customer accounts, such as addition of pre-paid services, transaction and/or usage history review, account suspension, or the like. Display device 312b may be operable to display selected information to a customer or prospective customer, and may receive inputs from such customer or respective customer, such as may be used to create a new account, purchase services, or the like. Customer service representative CSR may be able to facilitate customer use of display device 312b via the functions associated with area 520. For example, customer service representative CSR may facilitate purchase of pre-paid services by searching for and locating an account associated with a customer, such as customer C1, and activating a purchase function of the computer program product, whereafter customer C1 may be able to select an amount of services to purchase and/or may enter payment information, or the like, via display device 312b. Additionally, however, customer service representative CSR may alternatively complete such function alone via navigation of the computer program product without customer participation, or vice versa. Additionally, area 520 preferably allows customer service representative CSR to reboot an access point currently associated with a selected customer, such as a customer encountering a problem with an access point.

Similarly, areas 530 and 540 are preferably associated with management and reporting features of the computer program product, such as management of employee and/or customer accounts. For example, one or more of areas 530 and 540 may be accessed to allow a manager to provide employee reviews, review and/or change employee timecards, alter pay rates, manage employee and/or customer permissions, distribute promotional coupons or prizes, send messages to employees and/or customers, review transaction details, summaries, or reports, or the like.

Particularly, the computer program product is preferably configured to monitor and record selected activity of system 300, such as sales, payments, service usage, employee activity, and the like, whereby many accounting processes necessary for management of retail location 301 may be automatically performed by the computer program product, and outputs corresponding thereto may be provided. For example, the computer program product may automatically account for pre-paid services, by account, by facility, in total, and the like, to provide a record of accounts payable relating to pre-paid services. If promotional or incentive systems are employed to encourage sales, such as promotional sweepstakes, raffles, games, or rewards systems, the computer program product may likewise automatically monitor and record selected activity relating to such promotional systems.

According to a preferred embodiment, the Internet access service provided by system 300 may be promoted by such a promotional system. Specifically, the Internet access service is preferably promoted by providing a plurality of sweepstakes entries to a customer upon purchase of Internet access service. The entries are preferably associated with the customer's user account, such as by incrementing a field of a database, or the like, whereby a record of the number of entries associated with the customer may be maintained. The sweepstakes entries may be used to play a selected game using one of access points 321-326. The computer program product is preferably adapted to accommodate, control, and manage such entries, games, and any associated prizes or awards. Particularly, the computer program product is preferably operable to allow customer service representative CSR to assist with redeeming any prizes or awards won or earned by a customer, including the ability to review, via customer service terminal 311, one or more results of a game or the like. Furthermore, the computer program product is preferably operable to review, create, modify, and/or cancel a promotional system.

In another exemplary embodiment, such as in a hotel or a chain retail situation, each of terminals 121-126 may be formed as a router, hub, or other network access point, such as a plurality of wireless routers associated with respective ones of a plurality of different retail locations, hotel rooms or floors, or the like and connected to host 110 by network 130 in the form of a private network, a virtual private network, the Internet, or the like. In such an embodiment, where the user may likely provide their own computer or other equipment, and where such equipment may already be configured according to the user's preferences, system 100 may nonetheless maintain configuration information in a user account associated with a user. As will be understood in the art, such configuration information may include MAC address information for one or more device, security settings for the one or more device(s), or the like. Thus, when a user checks in to a hotel and is assigned a room, the terminal associated with that room may automatically be configured to operate with the user's equipment by a client program operable with the terminal and host 110. Furthermore, use of the access point may be monitored and recorded for billing purposes, or the like, if desired.

In another exemplary embodiment, such as in a retail situation, access points 121-126 may be formed as dedicated terminals adapted to facilitate customer activity at the location and connected to host 110 by network 130. For example, access terminals 121-126 may be check-in kiosks at one or more airports, car rental agencies, or the like, a self-service kiosk, such as a checkout kiosk, an automated teller machine (ATM), a vending machine, or the like. Upon logging on to any of access points 121-126, a user may be presented with a customized display, such as a customized menu of options, or the like. For example, in a shipping application, access points 121-126 may be formed as dedicated shipping terminals located at respective shipping service locations. Upon logging on to a selected one of terminals 121-126, the user may be presented with a customized service, such as a customized selection of shipping options, a customized address book, or the like.

As will be understood by those ordinarily skilled in the art, limitations on the type and/or volume of configuration information associated with a user account may be selected as desired, beneficial, or necessary, according to the specific embodiment or implementation. For example, where access points 121-126 are formed as personal computers, a greater amount and variety of configuration information, including files and/or programs, may be included for each user account, commensurate with the diverse uses to which the personal computer may be put. In any case, however, a user is preferably provided with the same experience regardless of which access point is selected for use, and such selected access point is preferably configured substantially identically as a previously selected access point.

Having thus described exemplary embodiments of the system and method of the present disclosure, it should be noted by those skilled in the art that the within disclosures are exemplary only and that various other alternatives, adaptations, and modifications may be made within the scope and spirit of the present invention. For example, while certain functions of the system have been described with reference to performance by selected components in certain ways, such functions may be performed by any suitable components in any suitable way to enable the functions described herein, or their equivalent functions. Accordingly, the present invention is not limited to the specific embodiments as illustrated herein, but is only limited by the following claims.

What is claimed is at least:

1. A method for providing a customized service experience comprising the steps of:
providing a system having a plurality of access points;
logging on to a selected one of the plurality of access points;
configuring the selected access point according to configuration information; and
providing a service via the selected access point,
wherein the service provided via the selected access point is customized by the configuration of the selected access point.

2. The method of claim 1, wherein the configuration is associated with a user account of an individual performing said step of logging on.

3. The method of claim 1, wherein the configuration information is obtained from a host operable with the selected access point.

4. The method of claim 1, wherein said step of configuring comprises at least one of installing a program on the selected access point, storing a file on the access point, and altering a setting of the access point.

5. The method of claim 1, wherein the plurality of access points are located at a retail location.

6. The method of claim 1, further comprising the step of modifying the configuration of the selected access point.

7. The method of claim 6, further comprising the steps of logging off the selected access point and modifying the configuration information according to the modified configuration of the selected access point.

8. The method of claim 7, further comprising the steps of logging on to a second selected access point and configuring the second selected access point according to the modified configuration information.

9. The method of claim 1, wherein each of the plurality of access terminals is formed as a personal computer having a computer readable medium.

10. The method of claim 9, wherein each personal computer includes a computer program product stored on the computer readable medium operable to perform said step of configuring the access point.

11. A system for providing a customized service experience, said system comprising:
a host computer and a plurality of access points operable with said host computer via a network to provide a service; and
a computer program product operable with said host and each of said plurality of access points to provide a user of a selected access point with a customized service experience.

12. The system of claim 11, wherein said host comprises a computer readable storage medium having configuration information stored thereon.

13. The system of claim 12, wherein said computer program product is operable to configure the selected access point to provide the customized service experience.

14. The system of claim 12, wherein said computer program product is operable to at least one of install a program on the selected access point, store a file on the selected access point, and modify a setting of a computer program product running on the selected access point.

15. The system of claim 11, wherein said computer program product is operable to access configuration information associated with the user accessing said selected access point and to configure said selected access point according to said configuration information associated with the user.
